(19) United States
(12) Patent Application Publication
(10) Pub. No.: US 2018/0082213 A1
(43) Pub. Date: Mar. 22, 2018

(54) SYSTEM AND METHOD FOR OPTIMIZING COMMUNICATION OPERATIONS USING REINFORCEMENT LEARNING

(71) Applicant: NEWVOICEMEDIA, LTD., Basingstoke (GB)

(72) Inventor: Alan McCord, Frisco, TX (US)

(21) Appl. No.: 15/442,667

(22) Filed: Feb. 25, 2017

Related U.S. Application Data
(63) Continuation-in-part of application No. 15/268,611, filed on Sep. 18, 2016.
(60) Provisional application No. 62/441,538, filed on Jan. 2, 2017.

(51) Int. Cl. G06N 99/00; G06N 7/00

(52) U.S. Cl. CPC G06N 99/005; G06N 7/005

(57) ABSTRACT

A system and method for automatically optimizing states of communications and operations in a contact center, using a reinforcement learning module comprising a reinforcement learning server and an optimization server introduced to existing infrastructure of the contact center, that, through use of a model set up a fully observable Markov decision process within a known time period, a resulting hyper-policy is computed through backwards induction to provide an optimal action policy to use in each state of a contact center, thereby ultimately optimizing states of communications and operations for an overall return over the time period considered.

### CROSS-REFERENCE TO RELATED APPLICATIONS

This application is a continuation-in-part of U.S. patent application Ser. No. 15/268,611, tided, “SYSTEM AND METHOD FOR OPTIMIZING COMMUNICATIONS USING REINFORCEMENT LEARNING” filed on Sep. 18, 2016, the entire specification of which is incorporated herein by reference.

### BACKGROUND OF THE INVENTION

### Field of the Art

The disclosure relates to the field of inside sales engagement, and more particularly to the field of the use of analytics and learning systems to optimize sales engagement and productivity of out-bound communications originating from multimedia contact centers.

### Discussion of the State of the Art

In the last forty years, “customer care” using remote call or contact centers (that is, remote from the perspective of the customer being cared for, as opposed to in-person customer care at, for example, a retail establishment, which is clearly not remote) has become a major activity of large corporations. Various estimates indicate that somewhere between 2 and 5 million people in the United States alone currently work on call or contact centers (in the art, “call center” generally refers to a center that handles only phone calls, while “contact center” refers to a center that handles not only calls but also other customer communication channels, such as electronic mail (“email”), instant messaging (“IM”), short message service (“SMS”), chat, web sessions, and so forth; in this document, applicant will generally use the term “contact center”, which should be understood to mean either call centers or contact centers, as just defined).

Contact centers are home to some of the more complex business processes engaged in by enterprises, since the process is typically carried out not only by employees or agents of the enterprise “running” the contact center, but also by the customers of the enterprise. Since an enterprise's customers will generally have goals that are different from, and often competitive with, the goals of the enterprise, and since customer care personnel (contact center “agents”) will often also have their own goals or preferences that may not always match those of the enterprise, the fact is that contact center processes lie somewhere between collaborative processes and purely competitive processes (like a courtroom trial). The existence of multiple competing or at least non-aligned stakeholders jointly carrying out a process means that, even when great effort is expended to design an efficient process, what actually occurs is usually a dynamic, surprising, and intrinsically complex mix of good and bad sub-processes, many of which occur without the direction or even knowledge of an enterprise's customer care management team.

Despite the complexity of contact center operations, it is a matter of significant economic importance to try to improve both the productivity of contact centers (from the enterprise's perspective) and the quality of the experience of the customers they serve. Accordingly, a number of well-known routing approaches have been adopted in the art, with the goal of getting each interaction to a most appropriate resource (resource being an agent or other person, or automated system, suitable for fulfilling a customer's service needs). For example, queues are still used in many contact centers, with most queues being first-in-first-out (FIFO) queues. In some cases in the art, enhancements to queue-based routing include use of priority scores for interaction, with higher-priority interactions being pushed “up” in queues to get quicker service. Queue-based routing has the advantage of simplicity and low cost, and is generally still in widespread use in applications where interactions are generally commodity-like or very similar (and therefore where the choice of a particular agent for a particular customer may not be that helpful).

An extension of the basic queuing approach is skills-based routing, which was introduced in the mid-1990s. In skills-based routing, each “agent” or customer service representative is assigned certain interaction-handling skills, and calls are queued to groups of agents who have the requisite skills needed for the call. Skills-based routing introduced the idea that among a large population of agents, some would be much more appropriate to handle a particular customer's need than others, and further that by assigning skills to agents and expressing the skills needed to serve a particular customer need, overall customer satisfaction would improve even as productivity did in parallel. However, in the art most skills are assigned administratively (sometimes based on training completed, but often based on work assignment or workgroup policies), and do not reflect actual capabilities of agents. Moreover, it is common practice in the art to “move interactions” by reassigning skills. That is, when traffic of inbound interactions begins to pile up in one group or skill set of a contact center, staff will often reassign skills of members in other groups so that the overloaded group temporarily becomes larger (and thereby clears the backlog of queued interactions). This common practice in the art further erodes any connection between skills as assigned and actual capabilities of agents, and in general basic skills-based routing has been unable to handle the complex needs of larger contact centers.

In one approach known in the art, the concept of a “virtual waiting room” where customers looking to be served and agents available to serve customers can virtually congregate, and a matching of customers to available agents can be made, much like people would do on their own if they were in a waiting room together. This approach, while attractive on the surface, is very impractical. For example, when there is a surplus of customers awaiting service, the waiting room approach becomes nothing more than determining, one agent at a time, which customer (among those the agent is eligible to serve) has the greatest need for prompt service; similarly, in an agent surplus situation, each time a customer “arrives” in the waiting room, a best-fit agent can be selected. Because generally there will be either an agent or a customer surplus, in most cases this waiting room approach is really nothing more than skills-based routing with a better metaphor.

Finally, because none of the three approaches just described satisfactorily meets the needs of complex routing situations typical in large contact centers, another approach that has become common in the art is the generic routing scripting approach. In this approach, a routing strategy designer application is used to build complex routing strategies, and each time an interaction requiring services appears (either by arriving, in the case of inbound interactions, or being initiated, in the case of outbound interactions), an appropriate script is loaded into an execution environment and executed on behalf of that interaction. An advantage of this approach is its open-endedness, as users can construct complex routing strategies that embody complex business rules. But this approach suffers from the disadvantage that it is very complex, and requires a high degree of technical skill on the part of the routing strategy designer. This requirement for skilled designers also generally means that changes in routing strategies occur only rarely, generally as part of a major technology implementation project (thus agile adoption and adaptation of enhanced business rules is not really an option).

Another general issue with the state of the art in routing is that, in general, one routing engine is used to handle all the routing for a given agent population. In some very large enterprises, routing might be subdivided based on organizational or geographic boundaries, but in most cases a single routing engine makes all routing decisions for a single enterprise (or for several). This means that the routing engine has to be made very efficient so that it can handle the scale of computation needed for large complex routing problems, and it means that the routing engine may be a point of failure (although hot standby and other fault-tolerant techniques are commonly used in the art). Also, routing engines, automated call distributors (ACDs), and queuing and routing systems in general known in the art today generally limit themselves to considering “available” agents (for example, those who have manually or automatically been placed in a “READY” status). Because of this, routing systems in the art generally require a real-time knowledge of the state of each potential target (particularly agents). In large routing systems, having to maintain continuous real-time state information about a large number of agents, and having to process routing rules within a centralized routing engine, have tended to require very complex systems that are difficult to implement, configure, and maintain.

Cloud-based contact centers (CC) and cloud communications platforms (CP) have a common approach of providing pre-integrated provision and management of voice, messaging and video communication channels. In the case of cloud-based contact centers, applications are prebuilt for specific contact center use cases such as call routing, customer service desktop, outbound sales, workforce management, outbound dialing, etc. On the other hand, cloud communications platforms provide APIs for developers to build custom applications. Many contact centers include a platform with rich APIs that enable custom application development, so the distinction between cloud-based contact centers and communications platforms is not always strong. However, use of these contact centers and communication platforms requires human interaction and management of complex communication processes such as ‘process and state tracking’, ‘uncertainty’, ‘hidden states’, ‘actions and actors’, ‘determination of actions leading to optimal outcomes’, ‘rewards and costs’, and ‘constraint propagation’. Even when great effort is expended to design an efficient process, what actually occurs is usually a dynamic, surprising, and intrinsically complex mix of good and bad sub-processes, many of which occur without the direction or even knowledge of an enterprise's customer care management team. Hence, it would therefore be desirable for these aspects to be managed with as much automation as possible to improve operations and activity actions of contact centers and communication platforms.

In the case of cloud-based contact centers, the interaction handling process for ‘process and state tracking’ is defined within the logic of each cloud-based contact center application but the logic can typically be customized through the use of routing rules for each channel type and agent skills. The technical state of the interactions, agents and callers is spread across the applications and the individual media servers. In the case of communications platforms, software developers are able to embed voice, messaging and video interactions directly into software applications and these applications share the technical state together with the media servers. However, the custom process, and the states or stages in the process, need to be regularly defined and managed by the developer, which is a taxing and time-consuming process.

Real-world communications scenarios are complex and involve large degrees of ‘uncertainty’. For example, from the simple fact that there are humans sending and responding to communications, there is uncertainty about knowing when interactions (voice, message, video) will start or terminate and what particular communications choices will be made on which particular channels. The technical “state” of multiple “parties” in an ongoing interaction chain evolves non-deterministically. Parties may switch between channels for communications due to random phenomena such as getting into or out of a car, meeting room or not wanting to communicate on a certain channel in the presence of other people, etc.

In addition to simple technical states that can be easily observed (e.g. whether someone is connected, speaking, silent, typing, dialing, etc.) there are other states that may be ‘hidden’ or unobservable to communication platforms and applications. A simple example of a hidden state is whether or not a person is “able to speak privately”, i.e. communicating in a private and not public setting. If a person is in a public setting, they may prefer to communicate by a text channel so they will not be overheard. This cannot be directly observed by the system (unless it was a video call or could be inferred from background voices). Also, as high quality intelligent speaking assistants and text bots become more prevalent it may become increasingly hard to know whether one party in communication is a human or a machine and thus the state of whether that party is a human or machine is no longer easily observable.

There are many kinds of ‘actions’ that are taken by the ‘actors’ or communicating parties (e.g. to start or end a communication session or to speak or type certain content or speak or write in a certain tone or to send a certain image or emoji, gesture, etc.). But as well as human actions, there are also actions to be taken by the communication platform ‘actors’ including how to route an interaction, to which person or on what channel to contact someone if they are not present. There are also platform infrastructure actions that may be required to, for example, ensure continuing good service under increasing load such as automated scale up and scale down of computer infrastructure nodes, etc.

A key challenge when faced with a large number of choices between possible actions is which specific actions should be taken under differing situations (and in what sequence) in order to achieve the best outcome over time. When considering tradeoffs between multiple possible actions, the concept of a ‘reward’ or benefit (or alternatively a penalty or ‘cost’) associated with an action and change of state and/or observation must be introduced.

In other approaches to optimization such as mathematical programming or constraint propagation, there is a concept of a constraint. In the case of an integer program, it could be that some linear combination of decision variables is greater than 5′ or less than ‘<’ some certain amount. In the case of constraint propagation, quite complex constraints need to be imposed on the allowed domains of integer decision variables. Slack variables can also be introduced to turn a “hard” inequality constraint into a “soft” constraint.

Management and control of cloud-based contact centers and communications platforms require significant effort to not only assign tasks efficiently, but also to be able to evaluate current trends and performance against historical data to project a desired outcome. Whilst a model may be created to be used as basis for some or all system processes, the act of selecting the appropriate model for the given parameters, as well as conditioning the model is quite complex. In-sampling and out-of-sampling techniques may be used by an enterprise's management team in an attempt to predict an efficient approach and process within the contact center systems. In-sampling may be used to evaluate a small subset of known, historical sample of training data to estimate parameters to create a model to predict and attempt to control a desired outcome. However, in-sampling typically draws an overly simplistic scenario of the model's forecasting ability, since commonly chosen algorithms usually are assigned to avoid large prediction errors, and are therefore, susceptible to error when used in the long-run. Using an out-of-sample analysis includes not only a set of historical data, but also a prediction iteration series where an evaluation is made on the results of the model used to readjust the model, and proceed with the adjustment. The use of out-of-sampling is iterative and time consuming, and results must be evaluated and further applied to another model to be tested for the desired outcome, which by that time, the desired outcome may have changed based on ever-changing conditions associated with call centers, as explained above.

FIG. 1 (PRIOR ART) is a typical system architecture diagram of a contact center 100, known to the art. A contact center is similar to a call center, but a contact center has more features. Whilst a call center only communicates by voice, a contact center adds email, text chat, and web interfaces to voice communication in order to facilitate communications between a customer endpoint 110, and a resource endpoint 120, through a network 130, by way of at least one interface, such as a text channel 140 or a multimedia channel 145 which communicates with a plurality of contact center components 150. A contact center 100 is often operated through an extensive open workspace for agents with work stations that may include a desktop computer 125 or laptop 124 for each resource 120, along with a telephone 121 connected to a telecom switch, a mobile smartphone 122, and/or a tablet 123. A contact center enterprise may be independently operated or networked with additional centers, often linked to a corporate computer network 130. Resources are often referred to as agents, but for inside sales, for example, they may be referred to as sales representatives, or in other cases they may be referred to as service representatives, or collection agents, etc. Resource devices 120 may communicate in a plurality of ways, and need not be limited to a sole communication process. Resource devices 120 may be remote or in-house in a contact center, or out-sourced to a third party, or working from home. They handle communications with customers 110 on behalf of an enterprise. Resource devices 120 may communicate by use of any known form of communication known in the art be it by a telephone 121, a mobile smartphone 122, a tablet 123, a laptop 124, or a desktop computer 125, to name a few examples. Similarly, customers 110 may communicate in a plurality of ways, and need not be limited to a sole communication process. Customer devices 110 may communicate by use of any known form of communication known in the art, be it by a telephone 111, a mobile smartphone 112, a tablet 113, a laptop 114, or a desktop computer 115, to name a few examples. Communications by telephone may transpire across different network types, such as public switched telephone networks, PSTN 131, or via an internet network 132 for Voice over Internet Protocol (VoIP) telephony. Similarly, VoIP or web-enabled calls may utilize a Wide Area Network (WAN) 133 or a Large Area Network 134 to terminate on a media server 146. Network types are provided by way of example, only, and should not be assumed to be the only types of networks used for communications. Further, resource devices 120 and customer devices 110 may communicate with each other and with backend services via networks 130. For example, a customer calling on telephone handset 111 would connect through PSTN 131 and terminate on a private branch exchange, PBX 147, which is a type of multimedia channel 145. A video call originating from a tablet 123 would connect through an internet 132, connection and terminate on a media server 146. A customer device such as a smartphone 112 would connect via a WAN 133, and terminate on an interactive voice response, IVR 148, such as in the case of a customer calling a customer support line for a bank or a utility service. Text channels 140, may comprise social media 141, email 142, SMS 143 or as another form of text chat, IM 144, and would communicate with their counterparts, each respectively being social server 159, email server 157, SMS server 160, and IM server 158. Multimedia channels 145 may comprise at least one media server 146, PBX 147, IVR 148, and/or BOTS 149. Text channels 140 and multimedia channels 145 may act as third parties to engage with outside social media services and so a social server 159 inside the contact center will be required to interact with the third party social media 141. In another example, an email server 157 would be owned by the contact center 100 and would be used to communicate with a third party email channel 142. The multimedia channels 145, such as media server 146, PBX 147, IVR 148, and BOTS 149, are typically present in an enterprise's datacenter, but could be hosted in a remote facility or in a cloud facility or in a multifunction service facility. The number of communication possibilities are vast between the number of possible resource devices 120, customer devices 110, networks 130, channels 140/145, and contact center components 150, hence the system diagram on FIG. 1 indicates connections between delineated groups rather than individual connections for clarity.

Continuing on FIG. 1 (PRIOR ART), shown to the right of text channels 140, and multimedia channels 145, are a series of contact center components 150, including servers, databases, and other key modules that may be present in a typical contact center, and may work in a black box environment, and may be used collectively in one location or may be spread over a plurality of locations, or even be cloud-based, and more than one of each component shown may be present in a single location or may be cloud-based or may be in a plurality of locations or premises. Contact center components 150, may comprise a routing server 151, a SIP server 152, an outbound server 153, a state and statistics server (also known and referred to herein as a STAT server) 154, an automated call distribution facility, ACD 155, a computer telephony integration server CTI 156, an email server 157, an IM server 158, a social server 159, a SMS server 160, a routing database 170, a historical database 172, and a campaign database 171. It is possible that other servers and databases may exist within a contact center, but in this example, the referenced components are used. Following on with the example given above, in some conditions where a single medium (such as ordinary telephone calls) is used for interactions that require routing, media server 146 may be more specifically a private branch exchange (PBX) 147, automated call distributor (ACD) 155, or similar media-specific switching system. Generally, when interactions arrive at media server 146, a route request, or a variation of a route request (for example, a SIP invite message), is sent to session initiation protocol SIP server 152, or to an equivalent system such as a computer telephony integration (CTI) server 156. A route request is a data message sent from a media-handling device such as media server 146 to a signaling system such as SIP server 152, the message comprising a request for one or more target destinations to which to send (or route, or deliver) the specific interaction with regard to which the route request was sent. SIP server 152 or its equivalent may, in some cases, carry out any required routing logic itself, or it may forward the route request message to routing server 151. Routing server 151 executes, using statistical data from state and statistics server (STAT server) 154 and (at least optionally) data from routing database 170, a routing script in response to the route request message and sends a response to media server 146 directing it to route the interaction to a specific target resource 120. In another case, routing server 151 uses historical information from a historical database 172, or real time information from campaign database 171, or both, as well as configuration information (generally available from a distributed configuration system, not shown for convenience) and information from routing database 170. STAT server 154 receives event notifications from media server 146 or SIP server 152 (or both) regarding events pertaining to a plurality of specific interactions handled by media server 146 or SIP server 152 (or both), and STAT server 154 computes one or more statistics for use in routing based on the received event notifications. Routing database 170 may of course be comprised of multiple distinct databases, either stored in one database management system or in separate database management systems. Examples of data that may normally be found in routing database 170 may include (but are not limited to): customer relationship management (CRM) data; data pertaining to one or more social networks (including, but not limited to network graphs capturing social relationships within relevant social networks, or media updates made by members of relevant social networks); skills data pertaining to a plurality of resources 120 (which may be human agents, automated software agents, interactive voice response scripts, and so forth); data extracted from third party data sources including cloud-based data sources such as CRM and other data from Salesforce.com, credit data from Experian, consumer data from data.com; or any other data that may be useful in making routing decisions. It will be appreciated by one having ordinary skill in the art that there are many means of data integration known in the art, any of which may be used to obtain data from premise-based, single machine-based, cloud-based, public or private data sources as needed, without departing from the scope of the invention. Using information obtained from one or more of STAT server 154, routing database 170, campaign database 172, historical database 171, and any associated configuration systems, routing server 151 selects a routing target from among a plurality of available resource devices 120, and routing server 151 then instructs SIP server 152 to route the interaction in question to the selected resource device 120, and SIP server 152 in turn directs media server 146 to establish an appropriate connection between customer devices 110 and target resource device 120. In this case, the routing script comprises at least the steps of generating a list of all possible routing targets for the interaction regardless of the real-time state of the routing targets using at least an interaction identifier and a plurality of data elements pertaining to the interaction, removing a subset of routing targets from the generated list based on the subset of routing targets being logged out to obtain a modified list, computing a plurality of fitness parameters for each routing target in the modified list, sorting the modified list based on one or more of the fitness parameters using a sorting rule to obtain a sorted target list, and using a target selection rule to consider a plurality of routing targets starting at the beginning of the sorted target list until a routing target is selected. It should be noted that customer devices 110 are generally, but not necessarily, associated with human customers or users. Nevertheless, it should be understood that routing of other work or interaction types is possible, although in any case, is limited to act or change without input from a management team.

What is needed in the art is a way to automate actions and optimize states of communications and operations in a contact center. Further what is needed in the art is an automated system and process for choosing which specific actions should be taken under differing situations, in a dynamic environment, and in what order these actions should be applied in order to achieve the best outcome over time.

### SUMMARY OF THE INVENTION

Accordingly, the inventor has conceived and reduced to practice, in a preferred embodiment of the invention a system for optimizing communication operations in a contact center, using a reinforcement learning module comprising a reinforcement learning server comprising at least a plurality of programming instructions stored in a memory and operating on a processor of a network-connected computing device and configured to observe and analyze historical and current data using a retrain and design server; develop a training set for use in a fully observable Markov chain model; assign desired rewards to specific states for use in a fully observable Markov decision process model; specify states, add time-labeled states, and create clusters within a set of hidden states added to the fully observable Markov decision process model; design and train the fully observable Markov decision process model using a retrain and design server to achieve a desired outcome; form the fully observable Markov decision process model by fitting the fully observable Markov chain model with a Baum-Welch algorithm to infer parameters based on observations; engage with an optimization server to apply and manage the fully observable Markov decision process model; record results of optimal actions carried out by the optimization server to a learning database; observe and analyze results of the optimal actions stored in the learning database; and repeat these steps iteratively; and an optimization server comprising at least a plurality of programming instructions stored in a memory and operating on a processor of a network-connected computing device and configured to apply optimal actions to states as assigned by the reinforcement learning server; manage and maintain a current revision of the fully observable Markov decision process model; assign an optimal action to each state to be executed by an action handler through interfaces with the contact center; initiate actions within the contact center through interfaces with an action handler; analyze events resulting from executing optimal actions within the contact center by way of interfaces with an event analyzer; record observations and actions resulting from execution of the optimal action; and send records of observations and actions resulting from execution of optimal actions to the reinforcement learning server.

According to a preferred embodiment of the invention, a method for optimizing states of communications and operations in a contact center, by using a reinforcement learning module, comprising the steps of: defining rewards to be used by the reinforcement training module for achieving a desired outcome or goal; assigning the rewards to a set of possible states at a given point in time, “L”; assigning specific actions resulting from the set of possible states for the given point in time “L”; forming a fully observable Markov decision process model by adding rewards, actions and hidden states, the hidden states comprising at least a set of specified states, time-labeled states, or clustered segments, to a Markov process at a given point in time “L”; solving the fully observable Markov decision process model to determine an optimal policy for the given point in time “L”; applying the optimal policy to determine an optimal action; determining the optimal action for the given point in time “L”; executing the optimal action at a new point in time “Li”; recording and observing results of the optimal action at the new point in time, “Li”; computing the current state based on the results of the optimal action at time stamp “Li”; matching observations under actions to fit a new model, at time stamp “Li”; forming a new fully observable Markov decision process model by adding rewards, actions and hidden states, the hidden states comprising at least a set of specified states, time-labeled states, or clustered segments, to a Markov process, at time stamp “Li”; repeating a portion of steps with an incremental time step at “n=1”, yielding a recorded and observed result of the optimal action at the new point in time “t2”; and continuing a portion of these steps iteratively to determine a final optimal action for a given point in time, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 (PRIOR ART) is a typical system architecture diagram of a contact center including components commonly known in the art.

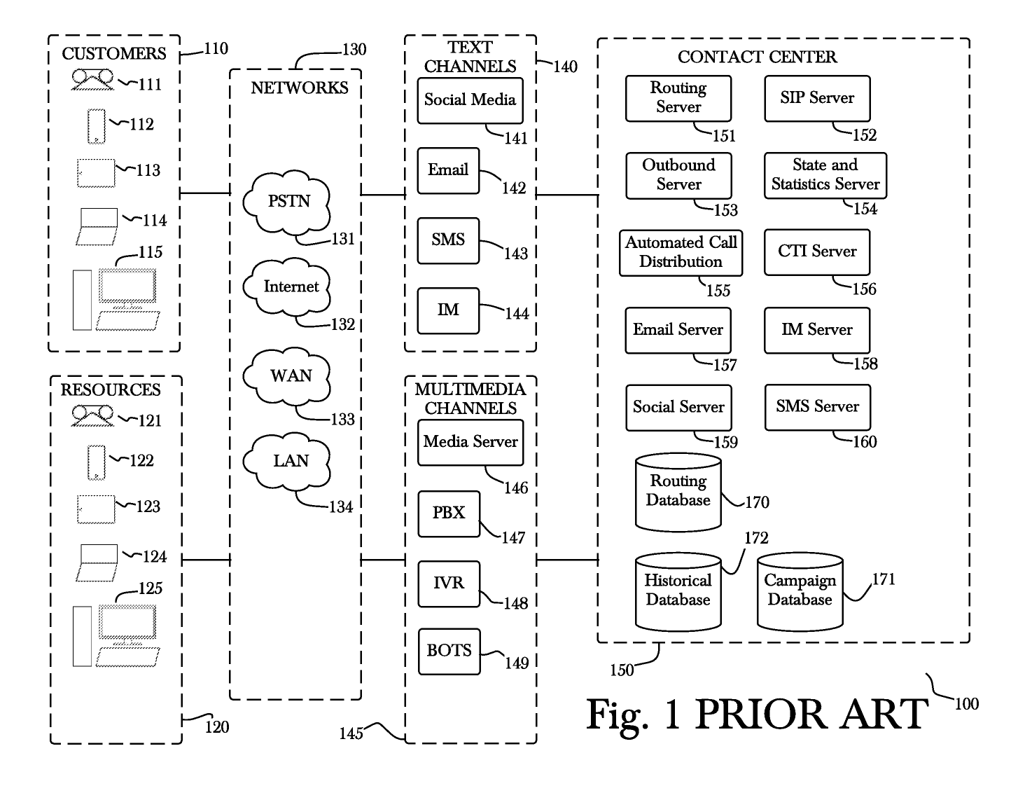

FIG. 2 is a block diagram illustrating an exemplary system architecture for a reinforcement learning module integrated into a contact center, comprised of a reinforcement learning server and an optimization server, according to a preferred embodiment of the invention.

FIG. 3 is a block diagram illustrating an expanded view of an exemplary system architecture for a reinforcement learning module that uses a reinforcement learning server comprised of a retrain and design server, a history database, training sets, a routing and action server, a learning database, and a state and statistics server; and an optimization server comprised of a model, a model manager, an event handler, an action handler, and interfaces, according to a preferred embodiment of the invention.

FIG. 4 is an exemplary state transition diagram illustrating a plurality of events that may occur in one or more possible stages during reinforcement learning, according to a preferred embodiment of the invention.

FIG. 5 is a flow diagram illustrating an exemplary method for creating a partially observable Markov decision process for use by the reinforcement learning module, according to a preferred embodiment of the invention.

FIG. 6 is a flow diagram illustrating an exemplary method for reinforcement learning, according to a preferred embodiment of the invention.

FIG. 7 is a flow diagram illustrating an exemplary method for optimizing states of communications and operations in a contact center by using a reinforcement learning module, according to a preferred embodiment of the invention.

FIG. 8 is a flow diagram illustrating an exemplary method for optimal interaction planning for outbound sales leads, depicted as a sales funnel with actions with a fully observable Markov decision process, according to a preferred embodiment of the invention.

FIG. 9 is a flow diagram illustrating an exemplary method for optimal interaction planning for outbound sales leads, depicted as a sales funnel with actions with a partially observable Markov decision process, according to a preferred embodiment of the invention.

FIG. 10 is a flow diagram illustrating an exemplary method for creating a fully observable Markov decision process for use by the reinforcement learning system, according to a preferred embodiment of the invention.

FIG. 11 is a an exemplary state transition diagram using a non-stationary hyper-policy for optimal interaction planning for routing communications and staffing agent resources, using a fully observable Markov decision process, according to a preferred embodiment of the invention.

FIG. 12 is a block diagram illustrating an exemplary hardware architecture of a computing device used in an embodiment of the invention.

FIG. 13 is a block diagram illustrating an exemplary logical architecture for a client device, according to an embodiment of the invention.

FIG. 14 is a block diagram showing an exemplary architectural arrangement of clients, servers, and external services, according to an embodiment of the invention.

FIG. 15 is another block diagram illustrating an exemplary hardware architecture of a computing device used in various embodiments of the invention.

### DETAILED DESCRIPTION

The inventor has conceived, and reduced to practice, in a preferred embodiment of the invention, an automated reinforcement learning module which may be connected to a system of a contact center such that optimized states of communications and operations may be achieved without the need for live user management or control of components or systems within the contact center.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Conceptual Architecture

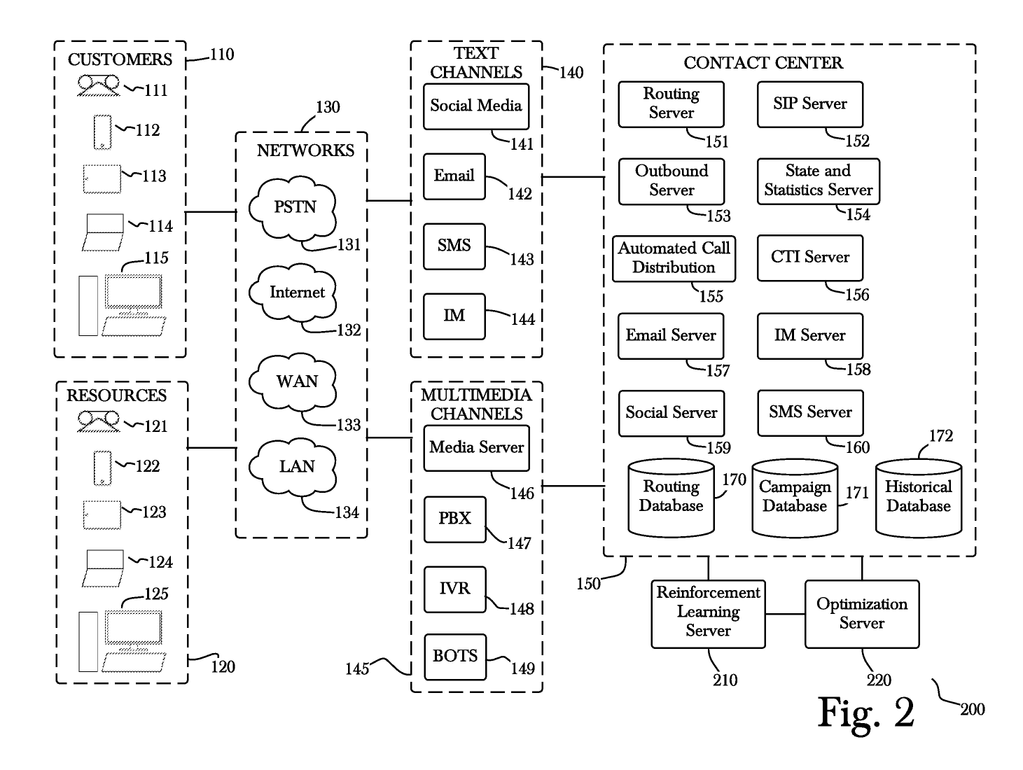

FIG. 2 is a block diagram illustrating an exemplary system architecture for a reinforcement learning module 300, integrated into a contact center 100, yielding a reinforcement learning system 200 comprising a reinforcement learning server 210, and an optimization server 220, according to a preferred embodiment of the invention. The optimization server 220, may communicate with a plurality of contact center components 150, as well as the reinforcement learning server 210, in order to manage and maintain models for operations and control of routing functions and other similar processes associated with connecting resource devices 120, to customer devices 110 in an optimized and efficient manner, such as increasing efficiencies by decreasing wait times or assigning tasks to available resources. The reinforcement learning server 210, may also communicate with a plurality of contact center components 150, in order to access historical and real-time data for incorporation into the design and retraining of models which are then applied by the optimization server 220, to assign tasks to a plurality of contact center components 150, to achieve a desired goal or outcome. The reinforcement learning server 210, and the optimization server 220, work together and in circular and iterative approaches to arrive at decisions, implement decisions as actions, and learn from results of actions which may be incorporated into future models. Collectively, reinforcement learning system 200 along with reinforcement learning server 210, and the optimization server 220, comprises a plurality of contact center components 150, adapted to handle interactions of one or more specific channel, be it text channels 140, or multimedia channels 145, as well as networks 130, resource devices 120, and customer devices 110.

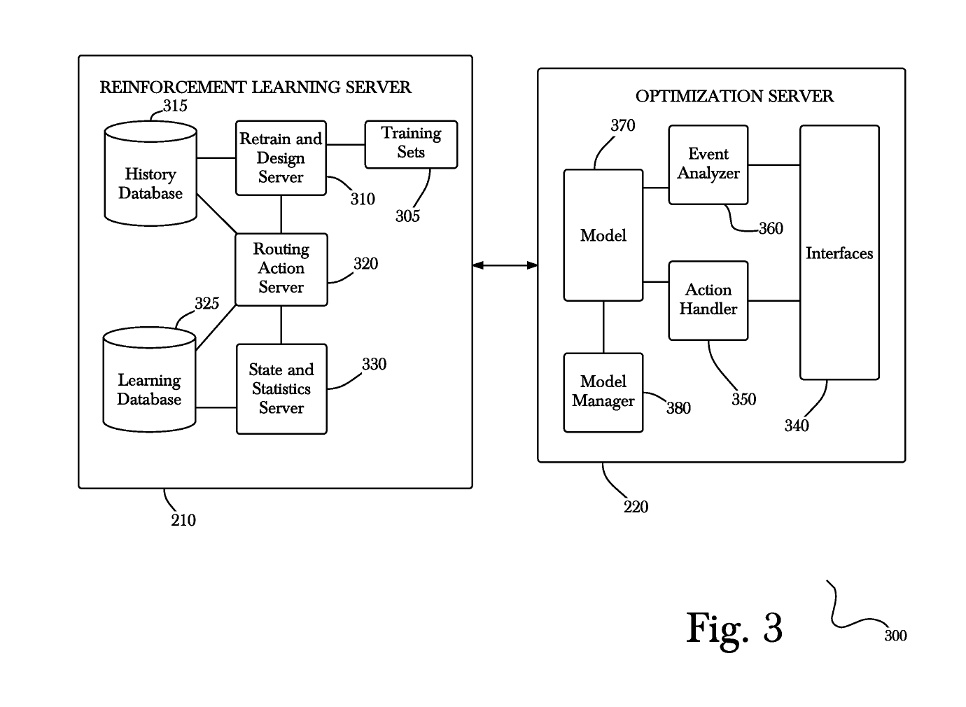

FIG. 3 is a block diagram illustrating an expanded view of an exemplary system architecture for a reinforcement learning module 300, that uses a reinforcement learning server 210, comprising a retrain and design server 310, a history database 315, training sets 305, a routing and action server 320, a learning database 325, and a state and statistics server 330; and an optimization server 220, comprising a Markov model 370, a model manager 380, an event handler 360, an action handler 350, and interfaces 340, according to a preferred embodiment of the invention. The state and statistics server 330, is responsible for representing and tracking current, real-time states, with a subsystem dedicated to pure Markov model representations of state that are efficiently stored in memory as sparse arrays and is capable of performing large scale and high speed matrix operations, optionally using specialized processors such as computation coprocessors such as Intel XEON PHI™ or graphics processing units (GPUs) such as NVidia TESLA™ instead of CPUs 41. Markov states include all information to be used, available within reinforcement learning system 200. Any aggregate counts or historical information is stored as a specific state for this purpose, in the learning database 325, and in the history database 315, respectively. In this way, a Markov assumption is not restrictive, and any process computed with the reinforcement learning server 210, and the optimization server 220, may be represented as a Markov process, within reinforcement learning system 200 with the reinforcing learning module 300.

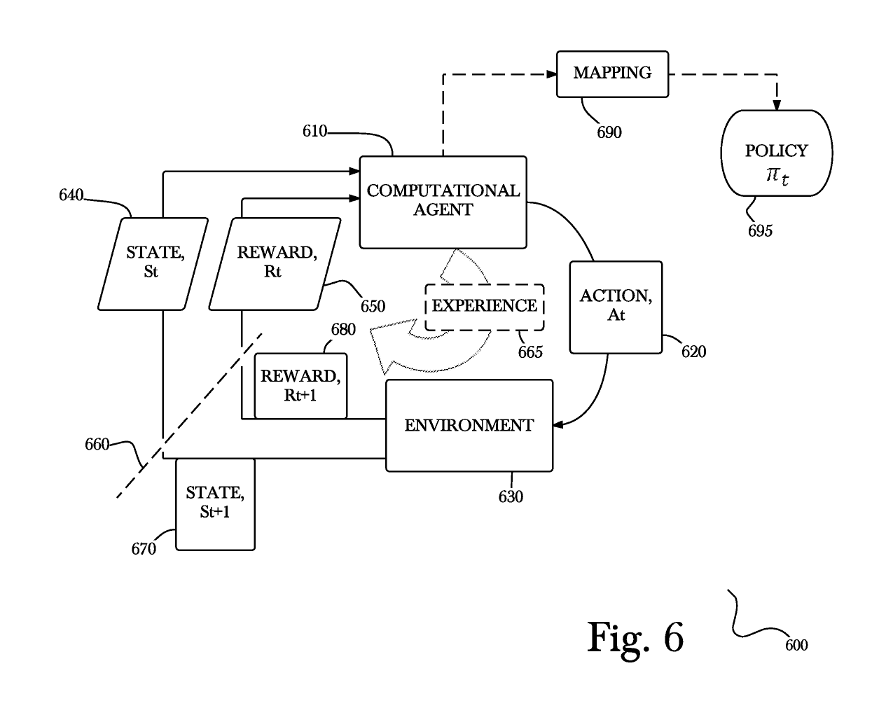

Reinforcement learning follows a productive process, training a model 370, and when the model 370 is ready, run it through subsets of training sets 305 to simulate real-time events. States are learned by reviewing history from the history database 315. Some examples of states include dialing, ringing, on a call, standby, ready, on a break, etc. Once the model 370 has been tested, it is set into motion in live action, and it controls a routing and action server 320 which then works to record more history to store in the history database 315, creates training sets 305, and reapply the model 370 based on more data, learning from more data. Once live, an optimization server 220 is engaged to control actions. Components of reinforcement learning system 200 work in “black-box” scenarios, as stand-alone units that only interface with established components, with no realization that other components exist in the system. Within the optimization server 220 an action handler 350 may act as a pacing manager, in communication with the campaign database 171 via interfaces 340. The action handler 350 may also concern itself with dialing and giving orders to hardware to dial, receive status reports, and translate dialing results, such as connection, transfer, hang-up, etc. The action handler 350 dictates actions to the reinforcement learning system 200. The model 370 is comprised of a set of algorithms, but the action handler 350 uses the model 370 to decide and determine optimal movements and actions, which are then put into action, and the optimization server 220 learns from actions taken in real-time and incorporates observations and results to determine a further optimal actions. The event analyzer 360 receives events from the state and statistics server 330, or the state and statistics server 154, or any of the other components 150, and then receives events as states, interprets events (states) in terms of the model 370, then decides what optimal actions to take and communicates with the action handler 350 which then decides how to implement a chosen action, and sends it via interface 340 out to any of the server components 150, such as state and statistics server 154, routing server 151, outbound server 153, and so forth. The event analyzer 360 receives events, interprets events in accordance with the model 370, and based on results, actions are determined to be executed. An action is a directive to do something. Actions are handled by the action handler 350. An event, or state, is a recording that something has been done. Actions lead to states, and states trigger actions. Refer to FIG. 6 for further disclosure on states and actions as they pertain to reinforcement learning. The model manager 380 maintains the model 370 while inputs are being received. Once put into action, the reinforcement learning module 300 is learning as time advances. Any event, or state, being introduced passes through the reinforcement learning server 210 and any event, or state, being acted upon by the optimization server 220 passes back through the reinforcement learning server 210. Following this logic, the reinforcement learning module 300 sees what is happening in a current state as well as records respective results of actions taken.

The optimization server 220 carries out instructions from the model 370 by analyzing events with the event analyzer 360, and sending out optimal actions to be executed by the action handler 350 based on those events. The reinforcement learning server 210, during runtime, may be receiving a plurality of events, and action directives, and interpreting them, and adjusting new actions as time advances. The model manager 380 receives increments from the model 370, and from the reinforcement learning server 210, and dynamically updates the model 370 that is being used. Model manager 380 maintains a version of what is the current model 370, as well as have the option to change the model 370 each time an incremental dataset is received, which may even mean changing the model every few minutes, or even seconds, OR after a prescribed quantity of changes are received.

### Detailed Description of Exemplary Embodiments

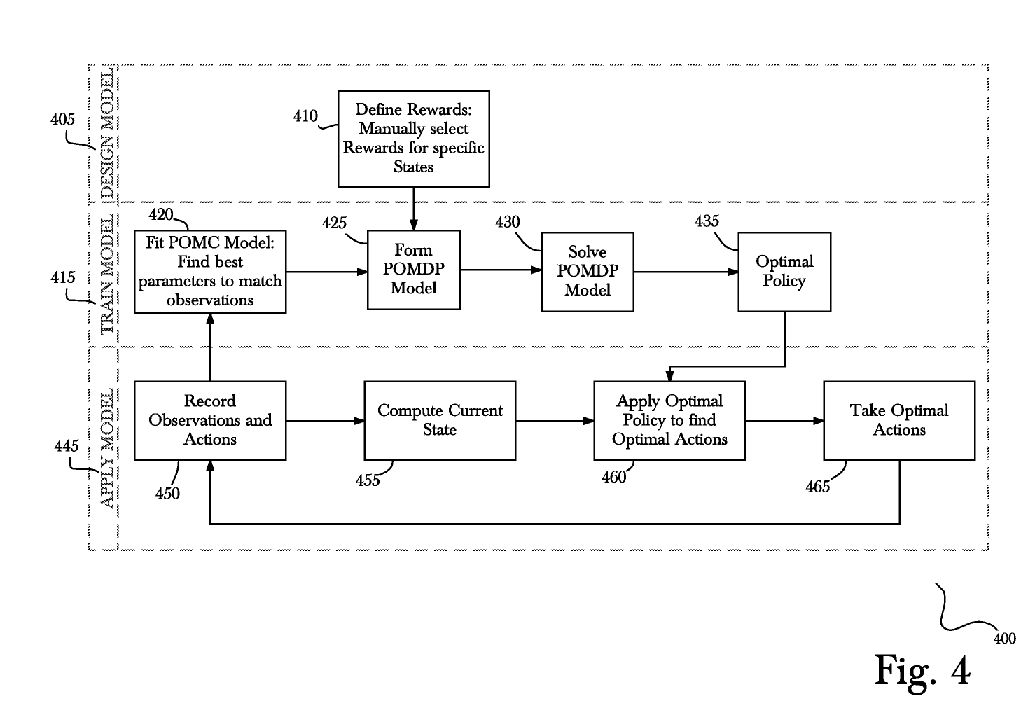

FIG. 4 is an exemplary state transition diagram 400 illustrating a plurality of events that may occur in one or more possible stages during reinforcement learning, according to a preferred embodiment of the invention. Reinforcement learning is an iterative process: design model 405, then train model 415, then apply model 445. After a model is applied in stage 445, results from application may be fed back into the training state 415, such that another model may be formulated, solved, and put into practice. This approach is further detailed in FIG. 6. Within the design model 405 stage, rewards are defined and manually selected and applied to specific states 410, to achieve a desired outcome from the overall system 200. In the train model 415 stage, first a partially observable Markov chain (POMC) is selected and fitted to find desirable parameters to match observations 420, then a Baum-Welch algorithm is used to infer parameters of the partially observable Markov chain based on observations. Rewards are added which then forms a partially observable Markov decision process (POMDP) model 425, which is then solved 430, to provide an optimal action policy 435, to use and apply 445 for each state within reinforcement learning system 200. With the optimal action policy 435 identified in the training stage by the reinforcement learning server 210, the optimization server 220 works to apply the optimal policy to find optimal actions 460 within reinforcement learning system 200. The optimization server 220 then takes optimal actions 465 by assigning them to the respective contact center components 150 via the action handler 350 and the associated interfaces 340. As optimal actions are taken, an event analyzer 360 records resulting observations and actions 450 and both sends the records back to the reinforcement learning server 210 to use to fit to a new partially observable Markov chain model 420 as well as keep within the event analyzer 360 to compute a current state 455 associated with the optimal action. The model manager 380 then prompts the reinforcement learning server 210 to process the recorded observations and actions 450 to find the best parameters to match the observations 420 while pushing the event analyzer 360 to compute the current state 455 to again, apply optimal policy to find optimal actions 460, and so forth. Hence, two cyclic processes emerge once a first optimal policy is applied: 460, 465, 450, 455, 460 as one cycle in the apply model 445 stage, and 460, 465, 450, 420, 425, 430, 435, 460 as the train model 415 cycle. The design model stage 405 and train model stage 415 is a probabilistic graphical method based on Markov's assumption that future behavior is completely determined by a current state. Yields of this approach are summarized in the following table, with different types of Markov models in cases where action may be taken to alter a probability of state transitions and whether or not states are fully observable.

| | | State transition probabilities controllable by actions? | |
|---|---|---|---|
| | | NO | YES |
| States fully | YES | Markov Process | Markov Decision Process |
| observable? | | (MP) | (MDP) |
| | NO | Hidden Markov Model | Partially Observable |
| | | (HMM) | Markov Decision Process |
| | | | (POMDP) |

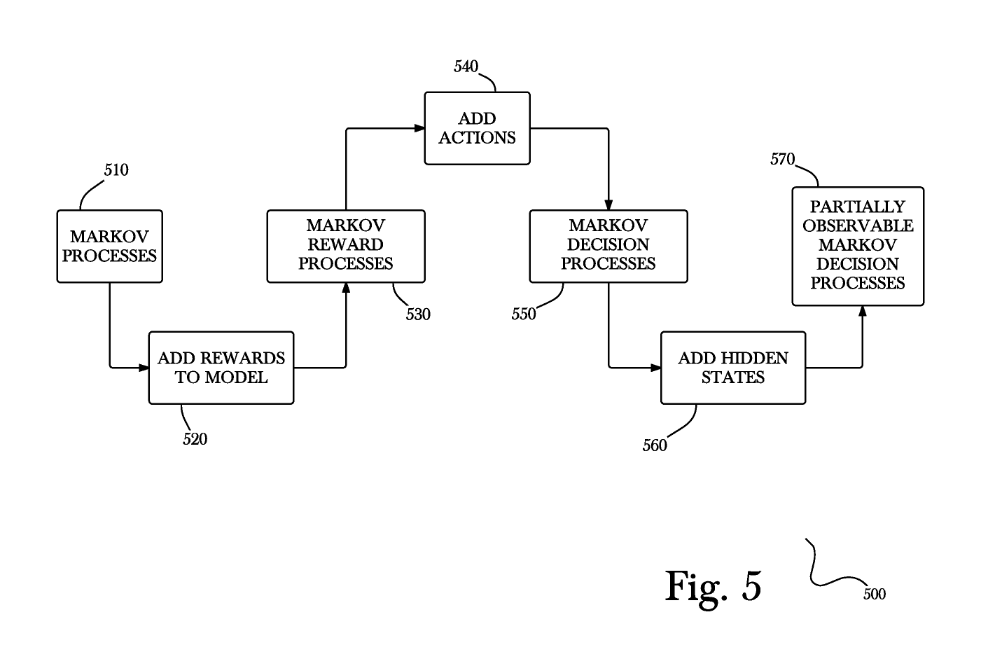

FIG. 5 is a flow diagram illustrating an exemplary method for creating a partially observable Markov decision process 500 for use by reinforcement learning module 300, according to a preferred embodiment of the invention. First, a Markov process 510 is selected for use, to which rewards are added 520 to become a Markov reward process 530. Decision processes require the concept of a reward in order to quantify which decision results in the better outcome over time. Actions are added 540 to create a Markov decision process 550, such that hidden states may be added 560 to obtain a partially observable Markov decision process (POMDP) 570.

According to a preferred embodiment, decisions of optimal actions to be executed to yield a most desirable outcome, even a best outcome, of processes running within a contact center may be expressed through a partially observable Markov decision process (POMPD) 570. The POMDP 570 is defined by a tuple [symbol] [symbol] , O, [symbol] , P, R, Z, γ [symbol] , where:
[symbol] is a finite set of possible states
O is a finite set of observations
[symbol] is a finite set of possible actions to be considered
P is a state transition probability matrix
R is a reward function
Z is an observation function
γ is a discount factor between zero and one

and a matrix P or Pₛₛ^{a}, is a conditional probability of a transition from state s at time t to a state s′ at time t+1 given that the state was s at time t and under the effect of action a,

P_{ss′}^{a}= [symbol] [Sₜ₊₁=s′|Sₜ=s,Aₜ=a]

a reward function R or Rₛ^{a} is an expected (mean) value of the reward at time t+1 after starting in state s at time t and under the effect of action a,

Rₛ^{a}= [symbol] [Rₜ₊₁|Sₜ=s,Aₜ=a]

an observation function Z or Z_{s′o}^{a} is a probability of observing observation o at time t+1 given that the system was in state s′ at time t+1 and had experienced action a,

Z_{s′o}^{a}= [symbol] [Oₜ₊₁=o|Sₜ₊₁=s′,Aₜ=a]

Standard reinforcement learning (RL) algorithms follow 3 different approaches. Valued Based (estimates the optimal value function), Policy-based (search for the optimal policy directly) and Model-based.

Value-based RL involve estimating the “value functions” of state-action pairs to estimate how good it is to perform a specific action in a given state based on accumulated future rewards. The value of a state s under a policy π is the expected return when starting in state s and following policy π.

$${v}_{π} ( s ) {=}^{def} {𝔼}_{π} [ {\sum }_{k = 0}^{∞} {γ}^{k} {R}_{t + k + 1} \vert {S}_{t} = s ]$$

The optimal policy π* is the one that maximizes ν_{π}(s).

Deep Reinforcement Learning however uses deep neural networks to represent the Value Function, the Policy and the Model. The loss function is optimized by stochastic gradient descent. This leads to Value-Based Deep RL, Policy-Based Deep RL and Model-Based Deep RL approaches for the solution of the POMDP.

Reinforcement learning follows a productive process, training a model 370, and when the model 370 is ready, run it through subsets of training data 305 to simulate real-time events. FIG. 6 is a process flow diagram illustrating an exemplary method for a reinforcement learning approach 600, according to a preferred embodiment of the invention. In this preferred embodiment, a computational agent 610 interacts with an environment 630 by receiving state 640 and reward 650 information and applies actions 620 to environment 630. The computational agent 610 is an automated agent, while contact center system 100 is represented within the environment 630. An iteration 660 is represented as a dotted line, indicating an incremental time step in process flow 600. The computational agent 610 and the environment 630 interact at each of a sequence of discrete time steps 660 t=0, 1, 2, . . . . At each time step 660, the computational agent 610 receives a representation of the environment's state 640 Sₜ ε [symbol] where [symbol] is the set of possible states and as a result selects an action 620 Aₜ ε [symbol] (Sₜ) where [symbol] (Sₜ) is the set of actions available in state 640 Sₜ. One time step 660 later, and partly due to the action 620 taken, the computational agent 610 receives a numerical reward 680 Rₜ₊₁ε [symbol] ⊂ [symbol] and finds the environment in a new state 670 Sₜ₊₁. The new reward 680 Rₜ₊₁ instead of the previous reward 650 Rₜ represents the new reward 680 due to the action 620 Aₜ in order to emphasize that the next reward 680 Rₜ₊₁ and next state 670 Sₜ₊₁ are jointly determined.

At each time step 660 the computational agent 610 implements a mapping 690 from states to probabilities of selecting each possible action 620. This mapping 690 is called the computational agent's policy 695, written πₜ where πₜ(a|s) is the probability that the action 620 at time t, Aₜ=a if Sₜ=s. Reinforcement learning methods specify how the computational agent 610 changes its policy 695 as a result of its experience 665, which is the accumulated result of each completed iteration through each time stamp 660. The computational agent's goal is to maximize the total amount of reward it receives over the long run. The time steps 660 need not refer to fixed intervals of real time but may refer to arbitrary successive stages of decision making and acting. Basically there are three signal types being sent between the computational agent 610 and its environment 620: (i) choices made by the computational agent 610 (the actions 620); (ii) basis of which choices are to be made by the computational agent 610 (the states 670); and (iii) the computational agent's 610 goal (the rewards 680). Note that states and actions may be low level communication states or actions, but they may also be quite complex. The computational agent 610 and environment 630 boundaries represent the limit of the computational agent's 610 absolute control, not its knowledge. Reward computation is external to the computational agent 610. In practice, multiple computational agents 610 may be operating concurrently, each with a different boundary. They may be hierarchical in that one computational agent may make high-level decisions which form parts of states faced by a second, lower-level computational agent which implements higher level decisions.

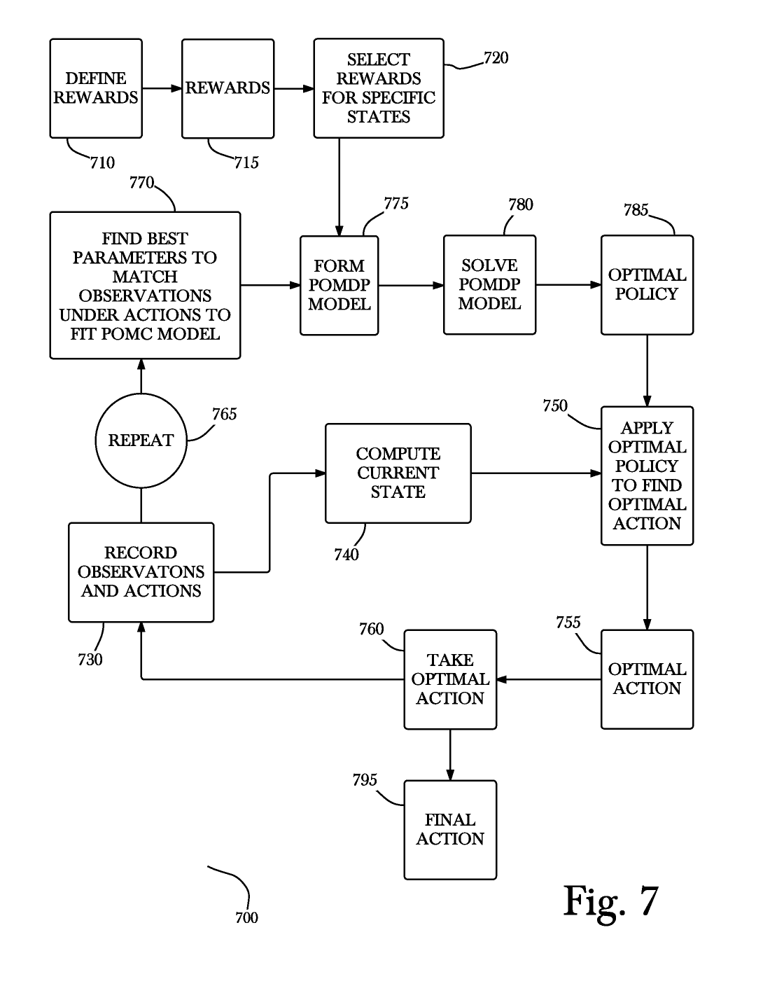

FIG. 7 is a flow diagram illustrating an exemplary method 700 for optimizing states of communications and operations in a contact center by using a reinforcement learning module 300, according to a preferred embodiment of the invention. With reference to FIG. 4, reinforcement learning is an iterative process, but once initiated and tested, may be set into motion in live, real-time action, controlled by optimization server 220 which then works with the reinforcement learning server 210 to record more history, develop more training sets, and reapply the model based on more data, learning from more data, and so forth. The reinforcement learning server 210, during runtime, is receiving events and action directives, and interpreting them, and adjusting new actions as it goes. The optimization server 220, works to carry out instructions from the model 370 by having its event analyzer 360 reviewing events and its action handler 350 sending out optimal action directives based on those events. But to initiate a process, rewards must first be defined 710 and, with a set of established rewards 715 for a given goal, rewards are selected for specific states 720. With a series of states and rewards set, a partially observable Markov decision process model (POMDP) is developed 775, in part from an initial partially observable Markov chain (POMC) 770 as well as from a series of selected rewards for specific states 720. Once the POMDP model is formed 775, it can be solved 780 and an optimal policy determined 785. The optimization server 220 is tasked to apply optimal policies to find an optimal action 750, resulting in an optimal action 755 (for the given state 640, reward 650, and time stamp 660) to be identified and executed, in a take optimal action step 760. When the optimal action 760 is taken, it becomes the final action 795 for that time stamp 660, but a history of the optimal action 760 and final action 795 is established to record observations and actions 730, which then feed back into reinforcement learning server 210 to repeat 765 learning and training to find best parameters to match observations under actions to fit an ideal or optimized partially observable Markov chain (POMC) model 770 in order to form a new POMDP model 775 at a new time stamp. Concurrently, resulting from the record of observations and actions 730, the initially formed POMDP model 775 is used to compute a current state 740 at the next time stamp, which then forms input into applying an optimal policy to find an optimal action 750 at the next iterative step. A model manager 380 receives increments from the model 370, from the reinforcement learning server 210 and dynamically updates the model 370 that is being used. Model manager 380 maintains a version of what is the current model 370 (associated with a given time stamp), as well as has an option to change the model by forming a new POMC 770 each time an incremental dataset is received, which may even mean changing the model every few minutes, or even seconds, or after a prescribed quantity of changes are received.

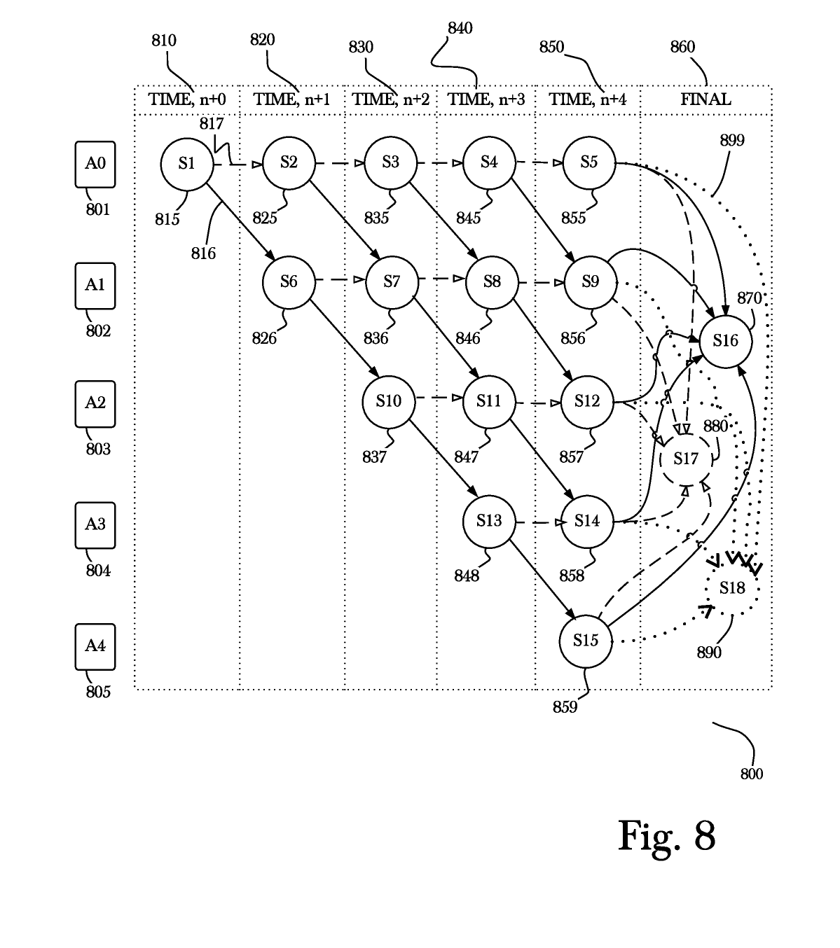

FIG. 8 is a process flow diagram illustrating an exemplary method 800, for optimal interaction planning for outbound sales leads, depicted as a sales funnel with actions based on a fully observable Markov decision process (MDP), according to a preferred embodiment of the invention. To improve readability of FIG. 8, transition lines between each terminal state: S16 870, S17 880, and S18 890 and all other states have been omitted. Viewing FIG. 8 from left to right, a first time increment, TIME n+0 810 represents an initial state S1 815 with no action taken, represented as A0 801. To progress to a next time step, a decision is made and the state S1 815 either takes an action 816 or no action 817. It is important to note, that while taking no action is, in principle, an action, an action of taking no action 817 is represented by a dashed line, and an action of taking action 816 is represented by a solid line in FIG. 8. Progressing S1 815 from an initial time, TIME n+0 810 to a next step, TIME n+1 820 has state S1 815 progressing either with no action 817 to become state S2 825, or S1 815 may progress with action 816 into a new state S6 826 associated with an action A1 802. At TIME n+1 820, two states exist: S2 825 and S6 826, as do two actions A0 801 and A1 802. Both states progress in similar fashion, with a decision to progress to a next time stamp TIME n+2 830, resulting in S2 825 either taking no action to become S3 835 or taking action to become S7 836. At the same time, S6 826 moves forward to the next time stamp TIME n+2 830 by either taking no action to become S7 836 or by taking action A2 803 to become S10 837 associated with action A2 803. At time TIME n+2 830 three states exist: S3 835, S7 836 and S10 837, each in a respective action category. All three states progress to time stamp TIME n+3 840 yielding four new states: a no action state S4 845 at action A0 801; a state S8 846 resulting from S3 835 taking an action A1 802 and from S7 836 taking no further action and remaining in action A1 802; a state S11 847 resulting from S7 836 taking an action A2 803 and from S10 837 taking no action; and S13 848 resulting from S10 837 taking an action A3 804. A next time stamp TIME n+4 is illustrated for exemplary purposes and as a next to last time stamp in process flow 800, but it is indicated for brevity, and the embodiment should not be taken to be exhaustive after five iterations, as illustrated. But for case of example, in a next time stamp TIME n+4 850, five states exist: S5 855 resulting from no action, A0 801, being taken; S9 856 resulting from S4 845 taking an action A1 802 and from S8 846 taking no further action and remaining in action A1 802; a state S12 857 resulting from S8 846 taking an action A2 803 and from S11 847 taking no action and remaining in action A2 803; a state S14 858 resulting from S11 847 taking an action A3 804 and from S13 848 taking no action and remaining in action A3 804; and S15 859 resulting from S13 848 taking an action A4 805. These five states: S5 855 at action A0 801, S9 856 at A1 802, S12 856 at A2 803, S14 858 at A3 804, and S15 859 at A4 805, may converge on a final 860 outcome at a time step following the previous step TIME n+4 850, by taking an action leading to a good outcome, S16 870; or by not taking an action leading to a bad outcome, S17 880; or by progressing to a state that is out of model, S18 890. Transitions of states to move out of model are indicated by a dotted line 899 and dotted lines 899 lead to the out-of-model state S18 890, and while out-of-model movements may be possible at all previous time stamps, illustration of incremental out-of-model movements has been omitted for clarity, as indicated above.

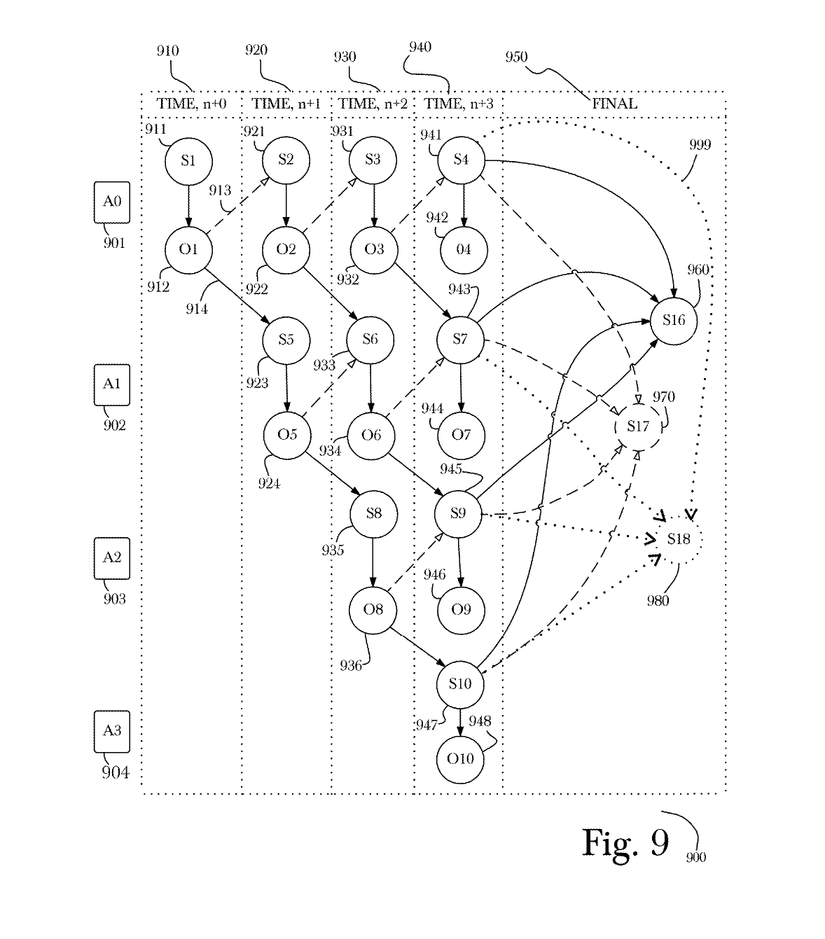

FIG. 9 is a process flow diagram illustrating an exemplary method 900 for optimal interaction planning for outbound sales leads, depicted as a sales funnel with actions as a partially observable Markov decision process, according to a preferred embodiment of the invention. To improve readability of FIG. 9, transition lines between each terminal state: S16 960, S17 970, and S18 980 and all other states have been omitted. Viewing FIG. 9 from left to right, a first time increment, TIME n+0 910 represents an initial state S1 911 and a corresponding observation O1 912, with no action taken, represented as A0 901. To progress to a next time step, a decision is made and the state S1 911 relating to the observation 912 either takes an action 914 or no action 913. It is important to note, that while taking no action is, in principle, an action, an action of taking no action 913 is represented by a dashed line, and an action of taking action 914 is represented by a solid line in FIG. 9. Progressing O1 912 from an initial time, TIME n+0 910 to a next step, TIME n+1 920 has an observation O1 912 progressing either with no action 913 to become state S2 921 with a corresponding observation O2 922, or O1 912 may progress with action 914 into a new state S5 923 associated with an action A1 902 and S5 923 transitions to O5 924 within action A1 902. At TIME n+1 920, two states with their matching observations exist: S2 921/O2 922 and S5 923/O5 924, as do two actions A0 901 and A1 902. Both states and corresponding observations advance in similar fashion, with a decision to advance to a next time stamp TIME n+2 930, resulting in O2 922 either taking no action to become S3 931 and O3 932 or taking action to become S6 933 and O6 934. At the same time stamp TIME n+1 920, O5 924 moves forward to the next time stamp TIME n+2 930 by either taking no action to become S6 933 which produces observation O6 934 and staying within action A1 902, or by taking action A2 903 to become S8 935 and corresponding observation O8 936 associated with action A2 903. At time TIME n+2 930 three states and their corresponding observations exist: S3 931/O3 932, S67 933/O6 934, and S8 935/O8 936, each pair in a respective action category, A0 901/A1, 902/A2, 903. All three states and corresponding observations advance to time stamp TIME n+3 940 yielding four new states and corresponding observations: a no action state S4 941 and corresponding observation O4 942 at action A0 901; a state S7 943 and corresponding observation O7 944, resulting from O3 932 taking an action A1 902 and from O6 934 taking no further action and remaining in action A1 902; a state S9 945 and corresponding observation O9 946, resulting from O6 934 taking an action A2 903 and from O8 936 taking no action; and state S10 947 with corresponding observation O10 948, resulting from O8 936 taking an action A3 904. These four state and observation pairs: S4 941/O4 942 at action A0 901, S7 943/O7 944 at A1 902, S9 945/O9 946 at A2 903, and S10 947/O10 948 at A3 904, may converge on a final 950 outcome at a time step following the previous step TIME n+3 940, by taking an action leading to a good outcome, S16 960; or by not taking an action leading to a bad outcome, S17 970; or by progressing to a state that is out of model, S18 980. Transitions of states to move out of model are indicated by a dotted line 999 and dotted lines 999 lead to the out-of-model state S18 980, and while out-of-model movements may be possible at all previous time stamps, illustration of incremental out-of-model movements has been omitted for clarity, as indicated above.

The reinforcement learning system 200 is designed to handle uncertainty at its core in terms of transition probabilities between states and probabilistic observation functions, and may perform optimal decision making under uncertainty. The reinforcement learning system 200 makes it possible to statistically infer hidden states even though they are not directly observable, as well as makes it possible to represent actions associated with the reinforcement learning system 200 and its communications platforms. In a preferred embodiment, the reinforcement learning system 200 finds an action policy that has a maximum value of expectation (mean) value of net accumulated reward (total return) over a time horizon in presence of uncertainty of different scenarios. Global constraints on actions are represented by an absence of impermissible actions in formulation of the model 370 and constraints on entering disallowed or undesirable states are represented by large penalties or negative action rewards for actions that have a non-zero probability of transition to disallowed states. Use of the reinforcement learning system 200 clearly enables optimal actions to be computed for any given state of the system 200 and for those actions to be executed.

Other applications are possible such as a plurality of outbound interactions, outbound dialing and pacing, workforce planning, resource allocation, for example, optimal interaction planning for outbound sales leads (when and how often and by what channel should an outbound lead be contacted), optimal skills based routing for inbound interactions (with certain parameters known, such as current system state, number of interactions in queue, number of agents available, paired with more positive rewards based on matching of a skill request with an agent skill, find most optimal actions of routing to an agent in each time step), optimal intraday staffing (actions are which agents to schedule at what time and for how long, as well as servicing of interactions by a well-matched agent), learning optimal channel and times for communication to a customer device, simplification of state handling in developer applications by updating state process and deaccessioning model to cloud as data, not as code, optimal cloud resource management, cloud platform optimizes its response to API actions to maximize reward, etc. In a general sense, an entire journey to customer and even to agent could be modeled as a Markov decision process, subject to actions along the way.

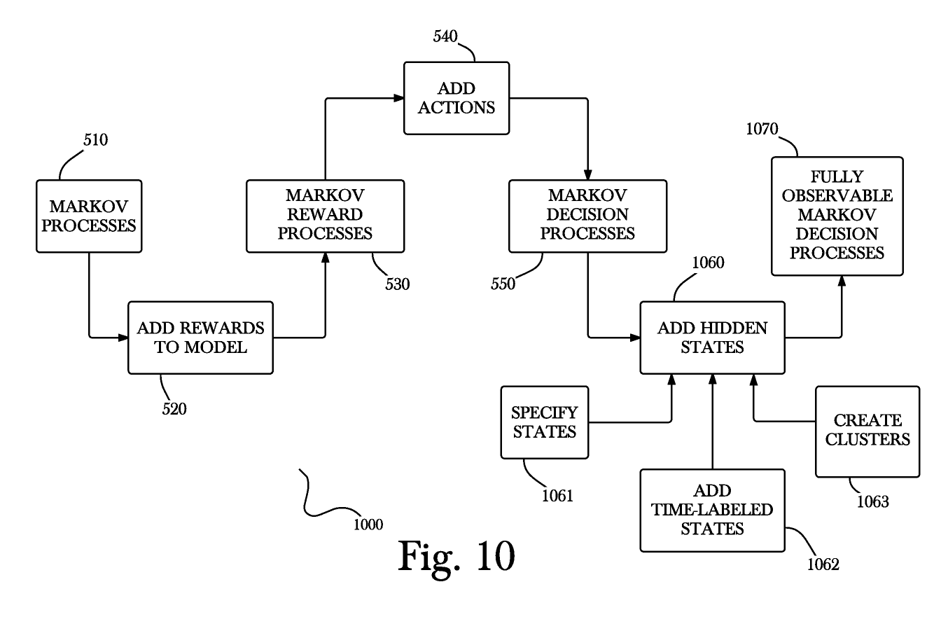

Considering the paragraphs above, a system using a Markov decision process may be built and configured for a contact center to include simultaneous states of interactions and agents. A fully observable Markov decision process may be implemented by creating a Markov chain with actions and rewards, allowing for a system to operate from a hyper-policy that specifies general actions to take such that rewards are maximized over a specified time or horizon. Actions need not be limited to typical routing actions, such as, for example, communication interactions and agent selection, but may be generalized to include actions related to scale-up or scale-down of resources 120 or scaling of other resources, such as, for example, cloud computing resources. Time may be discretely introduced to a Markov chain by introducing time-labeled states, which may be used to model waiting or service times. Therefore, by modifying the exemplary method for creating a partially observable Markov decision process 500 for use by reinforcement learning module 300, as illustrated in FIG. 10, an exemplary method for creating a fully observable Markov decision process 1000 for use by reinforcement learning module 300 may be implemented to optimize communication operations to include simultaneous specification of all states of interactions, including, but not limited to, interactions involving communications waiting in a queue, communications being served by agents; and may also be implemented to include simultaneous specification of all states of agents, including, but not limited to, idle, ready, and active or engaged; and may be implemented to include simultaneous specification of all states of agent resources and interactions.

FIG. 10 is a flow diagram illustrating an exemplary method for creating a fully observable Markov decision process 1000 for use by reinforcement learning module 300, according to a preferred embodiment of the invention. Similar to the process illustrated in FIG. 5, a Markov process 510 is selected for use, to which rewards are added 520 to become a Markov reward process 530. Decision processes require a concept of reward in order to quantify which decision results in an optimal outcome over a horizon, typically equating to time. Actions are added 540 to create a Markov decision process 550, such that a known, finite number of hidden states may be added 1060 to obtain a fully observable Markov decision process 1070. Within the step of adding hidden states 1060, the hidden states may be specified 1061, may be labeled with time 1062, and may be separated into clusters 1063 such that a number of states in the fully observable Markov decision process 1000 are known and limited, where clusters may contain segments of interactions or agent resources, and the hidden states 1060 interact with clusters and not individual agent resources or interaction channels. Segmentation of interactions into clusters may be accomplished using prior knowledge and application rules applied, such as, for example: skill sets requested by a business type, e.g., product X sales, product Y service, or text channel 140 type or multimedia channel 145 type; or value segment of a customer 110 based on status or designation of preferred service level, such as platinum, gold, silver, etc., based on an expected return. Further, segmentation of interactions into clusters may be accomplished by implementing a supervised machine learning model to predict and classify an interaction state from available input data, and where no data is available, a suitable set of cluster labels may be used as segments, and applied to compute a clustering algorithm to historical data such that initial input data needed for an iterative process may be synthesized. Segmentation of agent resources may be accomplished by using prior knowledge of skills possessed by each agent resource 120, which may include hourly rate or implicit skill set in a business type, or may be accomplished by implementing a supervised machine learning model to predict and classify an agent resource 120 state from available input data, and where no data is available, a suitable set of cluster labels may be used as segments, and applied to compute a clustering algorithm to historical data such that initial input data needed for an iterative process may be synthesized.

According to a preferred embodiment, decisions of optimal actions to be implemented and executed to yield a most desirable outcome, even a best outcome, of communication operations running within a contact center may be expressed through a fully observable Markov decision process (MPD) 1070. In a similar fashion to the derivation of POMDP 570, the MDP 1070 is defined by a tuple [symbol] , [symbol] , [symbol] , P, R, γ [symbol] , where:
[symbol] is a finite set of possible states
[symbol] is a finite set of possible actions to be considered
P is a state transition probability matrix (a separate matrix for each action)
R is a reward function
γ is a discount factor between zero and one

An overall state of the reinforcement learning system 200 may be represented as [symbol] , and may be decomposed into a finite number of possible states, (of interactions) N_{Q}, in a queue: Q0, Q1, . . . Q[N_{Q}−1]; and into a finite number of possible states, (of interactions being addressed by agent resources) N_{A}, agent resource state: A0, A1, . . . [N_{A}−1], where a special state Q0 corresponds to an empty queue and where a special state A0 corresponds to all agent resources idle. Transition probabilities may change over time due to any number of uncontrolled actions, such as customer 110 disconnecting due to impatience, or agent resource 120 delayed reporting of availability. The Markov decision process model 1070 may be created as a non-stationary policy, or hyper-policy, by expanding a state definition to include an explicit time stage label, t0, t1, . . . , tN, and considering a state subspace Q to be enlarged by including time units spent waiting in queue and a state subspace A to include a number of time units spent being engaged or active. The finite number of possible states, [symbol] , of the queue, N_{Q}, may be determined considering all possible interactions types (skill request expressions) and number of interactions of each type waiting in each queue for a range of time units up to a maximum model queue time (horizon), such that an order of interactions in a queue is not important, only wait time counts are captured. Alternatively, queue states may be distinguished by order. All possible combinations of queue interactions and agent resource states may be specified in the overall state space of the reinforcement learning system 200, where S={Q0A0, Q1A0, Q1A1, Q2A0, Q2A1, Q2A2, . . . , QnAn}. Similarly, the Markov decision process model 1070 may be further extended to a partially observable model, for example, when relating a known state of a customer 110.

A non-stationary policy, otherwise termed herein as a hyper-policy, specifically as referenced above, may be implemented to identify optimal actions to take at state, [symbol] , with a known number of ‘t’ stages within a specified horizon, H. This may be represented as π(s,t), where π:S×T->A, and T comprises a set of non-negative integers. A finite planning horizon, H, comprising a finite number of stages, ‘t’, may be established such that a finite count of actions may be determined. Actions may involve routing of interactions to agent resources or changing a quantity of available or potentially-engaged agent resources according to changing needs of the reinforced learning system 200. Given a Markov decision process 1070 and a known horizon, H, for example, one day, an optimal finite-horizon policy may be computed using, for example, a backward induction algorithm that starts from the end of the known horizon, e.g. one day, and working backwards to find optimal actions to take at each stage or time point, t, manipulated to determine an optimal value function for a know horizon, H. Backwards induction algorithms require some level of initial approximation in order to compute and optimized policy, and may follow: myoptic policies, which optimize current cost but do not apply forecasts or representations of future decisions; look-ahead policies, which explicitly optimize over a future horizon with approximated future data and actions applied; policy function approximations, which directly return an action in a given state with no embedded optimization or forecast of future data applied; and value function approximations (greedy policies) using an approximation of value being in a future state as a result of a decision currently made, with any impact of future actions solely in this value function.

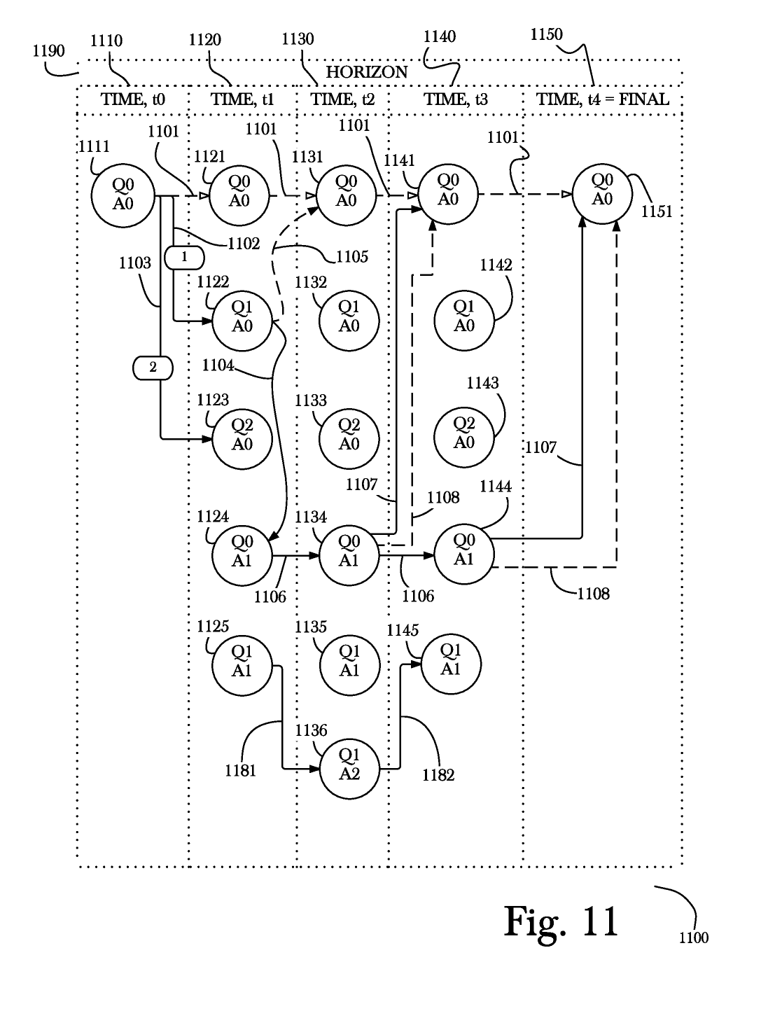

FIG. 11 is a an exemplary state transition diagram 1100 using a non-stationary hyper-policy over a given horizon 1190 for optimal interaction planning and for routing communications and staffing agent resources, using a fully observable Markov decision process 1070, according to a preferred embodiment of the invention. A simplified view of state transitions, actions, and rewards is illustrated. In state transition diagram 1100, a horizon 1190 of one day is separated into five time slots: TIME, t0, 1110, representing the beginning of the horizon 1190; TIME, t1, 1120, representing a next stage of horizon 1190; TIME, t2, 1130, representing a next stage of horizon 1190; TIME, t3, 1140, representing a next stage of horizon 1190; and TIME, t4−FINAL, 1150, representing a final or last stage of horizon 1190. In the exemplary state transition diagram 1100, a start of day one 1110 is in a state t0Q0A0 1111 with no calls in queue, represented by a dashed line and empty arrow 1101, and no agent resources engaged, A0. There is a non-zero probability of one call 1102 arriving at stage t1 1120, where the state transitions to t1Q1A0 1122 (one call in queue and no agent resources engaged). A routing action 1104 is taken resulting in a state t1Q0A1 1124 with no calls in queue and one agent resource engaged. At state t1Q1A0 1122, should the call in queue be dropped or abandoned, an empty call path 1105 transitions to a new stage state t2Q0A0 1131. Another possibility to arrive at t2Q0A0 1131 may come from a previous stage at t1 1120, whereby no call arrives from t1 Q0A0 1121 via a no call in queue 1101. Following this logic, and continuing from t1Q0A1 1124, a call may be in progress 1106 leading to t2Q0A1 1134, with no call in queue and one agent resource engaged at time t2 1130. At a next stage, t3 1140, a call may remain in progress 1106 yielding a t3Q0A1 1144 state or the call may terminate by either a sale being made 1107 or no sale being made 1108, transitioning to state t3Q0A0 1141. Assuming the agent resource remained engaged on the call through state t3Q0A1 1144, an outcome is finally concluded at the end of day in stage t4−FINAL 1150, with a sale being made 1107 (positive outcome) or a sale being lost 1108 (negative outcome) returning the state to t4Q0A0 1151. In another case, at state t1 Q2A0 1123, two calls 1103 are in queue with zero agent resources engaged, A0. With no agent resources allocated, state t1 Q2A0 1123 transitions to t2Q2A0 1133 at the next time stage t2 1130 and on to t3Q2A0 1143. Similarly, t3Q1A0 1142 results from t2Q1A0 1132 which results from t1Q1A0 1122 assuming neither routing action 1105/1106 occur. Within the same case 1100, assuming horizon 1190, other actions may be executed, such as, for example, engaging a second agent resource by transferring a call at t1 1120 in state t1Q1A1 1125 to state t2Q1A2 1136 by routing and engaging a second agent resource 1181. It may be that a second agent resource is needed for a specific skill set or to engage at a specific performance level, or to relieve a first agent resource to free up for a next-queued call. A second agent may be disengaged by rerouting to the first agent 1182 to state t3Q1A1 1145. Assuming no action is taken from state t1Q1A1 1125, the state progresses to t2Q1A1 1135 and possibly on to t3Q1A1 1145 yielding no results and no action. Other actions may be performed, such as engaging new agent resources, assigning new engagements to agent resources, or disengaging agent resources. Many logical constraints are possible, and not all possible connections between states are identified within FIG. 11, but examples given follow a left-to-right time dependency, which itself may be altered to suit specific system logic, and should not be understood as limiting in any way.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

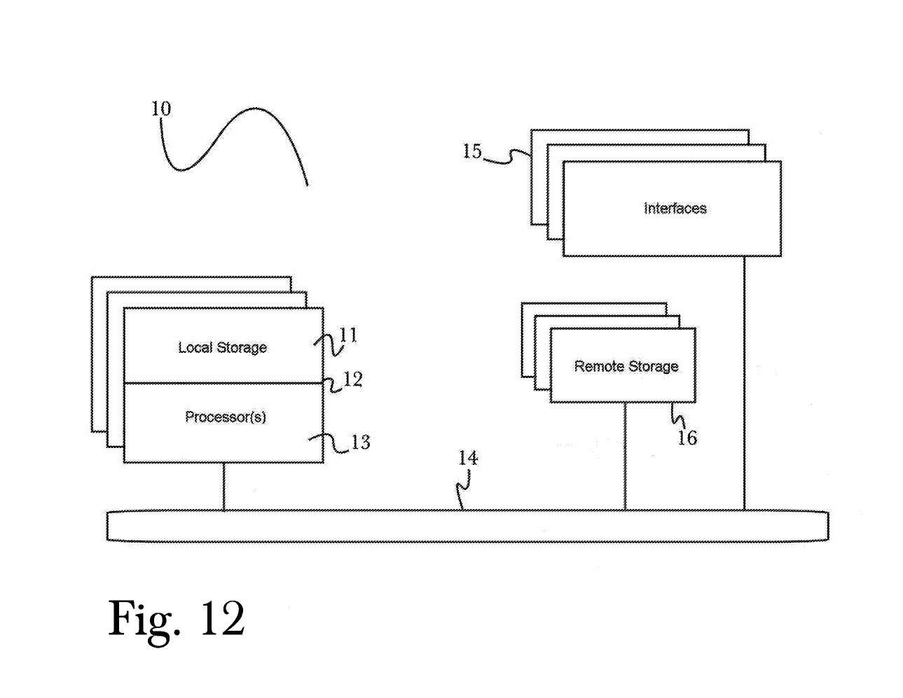

Referring now to FIG. 12, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 12 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

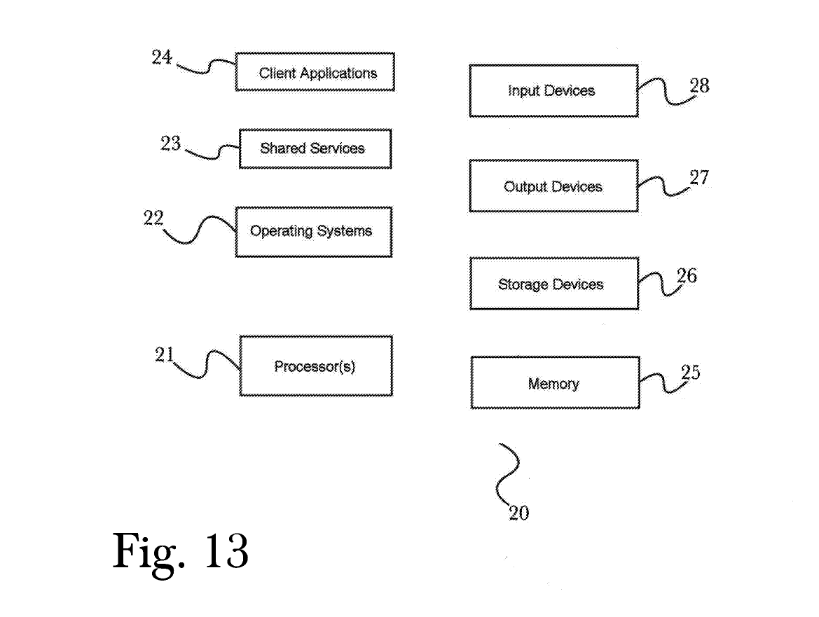

In some embodiments, systems according to the present invention may be implemented on a standalone computing system. Referring now to FIG. 13, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 12). Examples of storage devices 26 include flash memory, magnetic hard drive, CD-ROM, and/or the like.

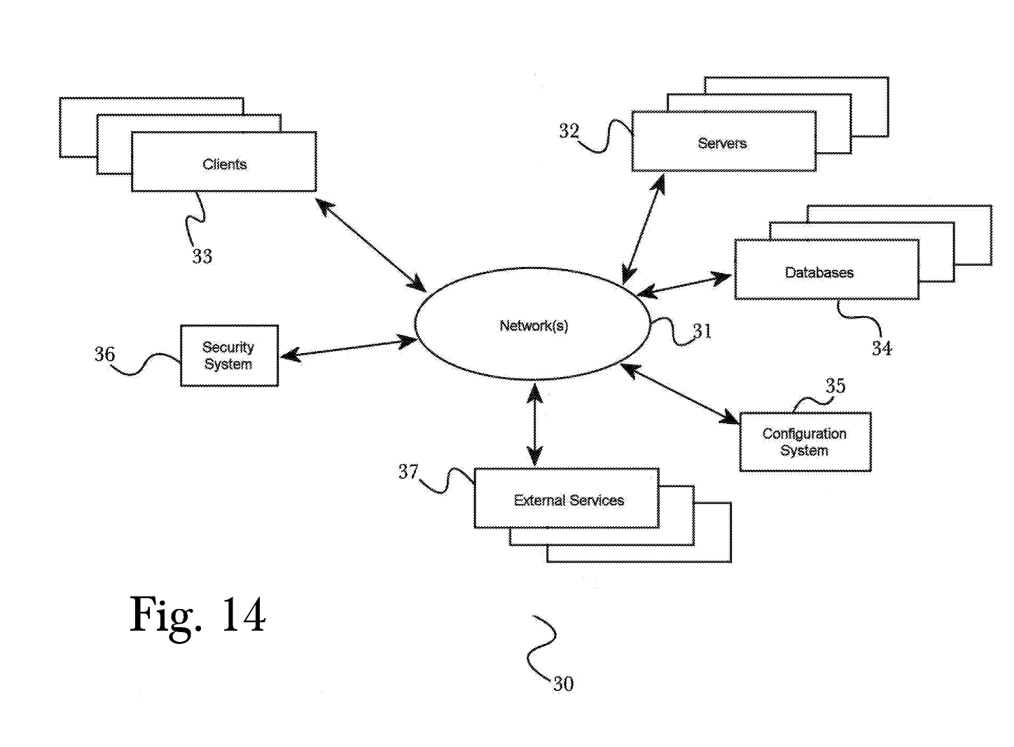

In some embodiments, systems of the present invention may be implemented on a distributed computing network, such as one having any number of clients and/or servers. Referring now to FIG. 14, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 13. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as Wi-Fi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

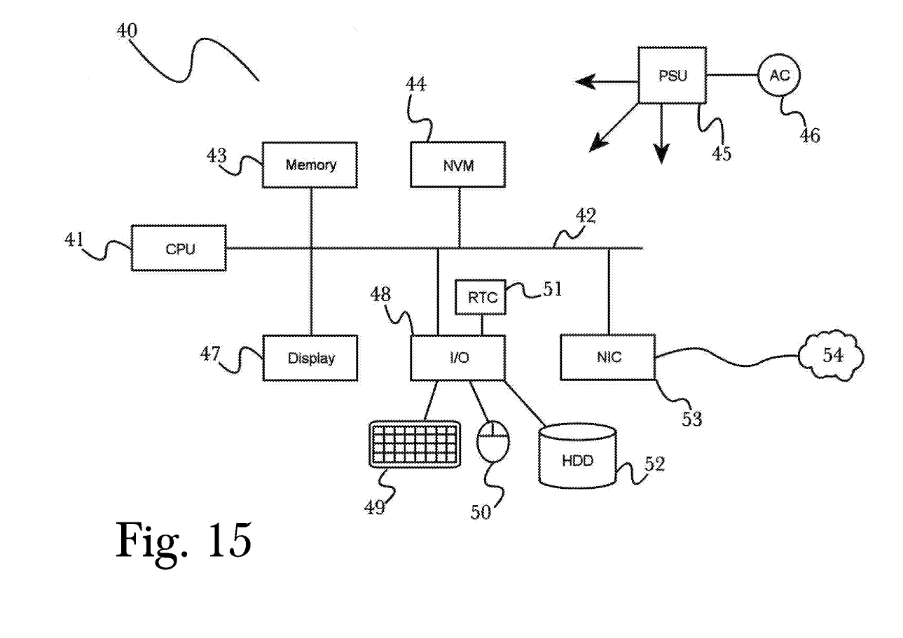

FIG. 15 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

1. A system for optimizing communication operations in a contact center using a reinforcement learning server, comprising:
a reinforcement learning server comprising at least a first plurality of programming instructions stored in a first memory and operating on a first processor of a first computing device, wherein the first plurality of programming instructions, when operating on the first processor, cause the first processor to:
receive a plurality of historical data from a contact center;
form a partially-observable Markov chain model by fitting at least a portion of the historical data with a Baum-Welch algorithm to infer model parameters associated with hidden states based on known observations;
develop a training set for use in the partially-observable Markov chain model, the training set being based at least in part on historical data;
provide the partially-observable Markov chain model to an optimization server;
record and analyze the results of the optimization server's operation;
an optimization server comprising at least a second plurality of programming instructions stored in a second memory and operating on a second processor of a second computing device, wherein the second plurality of programming instructions, when operating on the second processor, cause the second processor to:
receive a partially-observable Markov chain model from a reinforcement learning server;
assign and apply a plurality of actions to each of a plurality of states in the partially-observable Markov chain model;
direct the operation of a plurality of contact center systems based at least in part on the assigned actions;
record and analyze a plurality of observations based on the execution of the assigned actions;
provide the observation data to the reinforcement learning server;
a retrain and design server comprising at least a third plurality of programming instructions stored in a third memory and operating on a third processor of a third computing device, wherein the third plurality of programming instructions, when operating on the third processor, cause the third processor to:
observe and analyze a plurality of historical data from a contact center;
provide at least a portion of the historical data to a reinforcement learning server for use in a partially-observable Markov chain model;
define a plurality of reward values to direct the operation of the reinforcement learning server; and
design and train a Markov decision process model based at least in part on the partially-observable Markov chain model, using at least a portion of the defined reward values.

2. A method for optimizing states of communications and operations in a contact center using a reinforcement learning server, comprising the steps of:
receiving, at a retrain and design server comprising at least a first plurality of programming instructions stored in a first memory and operating on a first processor of a first computing device, a plurality of historical data from a contact center;
defining a plurality of reward values to direct the operation of a reinforcement learning server;
providing at least a portion of the historical data to a reinforcement learning server for use in a partially-observable Markov chain model;
forming, using a reinforcement learning server comprising at least a second plurality of programming instructions stored in a second memory and operating on a second processor of a second computing device, a partially-observable Markov chain model based at least in part on the historical data, by fitting at least a portion of the historical data with a Baum-Welch algorithm to infer model parameters associated with hidden states based on known observations;
assigning, using an optimization server comprising at least a third plurality of programming instructions stored in a third memory and operating on a third processor of a third computing device, a plurality of actions to each of a plurality of states within the partially-observable Markov chain model;
directing the operation of a plurality of contact center systems based at least in part on the assigned actions; and
training a Markov decision process model based at least in part on the partially-observable Markov chain model, using at least a portion of the defined reward values.
